(19) United States
(12) Patent Application Publication
(10) Pub. No.: US 2012/0192975 A1
(43) Pub. Date: Aug. 2, 2012

(54) HYDRAULIC CONTROL VALVE HAVING A PILOT PISTON WITH FOUR CONTROL EDGES ARRANGED INSIDE THE HOLLOW SPOOL

(75) Inventors: THOMAS LEHNER, Schleiden (DE); Frank Baumanns, Willich-Anrath (DE); Viktor Vogel, Monchengladbach (DE); Walter Krips, Grevenbroich (DE)

(73) Assignee: Parker Hannlfin Manufacturing Germany GmbH & Co., KG, Bielefeld (DE)

(21) Appl. No.: 13/289,293

(22) Filed: Nov. 4, 2011

(30) Foreign Application Priority Data
Nov. 5, 2010 (DE) 102010050325.8

(51) Int. Cl. F16K 11/074

(52) U.S. Cl. 137/625.46

(57) ABSTRACT

Provided is a hydraulic control valve with a main stage, having a movable spool valve in a valve housing with at least four ports P, A, B, T to block or release the ports, and provided with control edges formed on piston collars, and with a hydraulic pilot stage provided to control the spool valve of the main stage. If the spool valve of a hydraulic control valve requires a control to release or block the valve housing ports, in addition to electromechanical pilot valves, hydraulically operating pilot stages are also known, in which a pilot valve, controlled by means of a connected drive, regulates a stream of hydraulic fluid acting upon the spool valve of the hydraulic main stage and therefore moving the spool valve between its control positions.

### SUMMARY

The invention concerns a hydraulic control valve with a main stage, having a movable spool valve in a valve housing with at least four ports P, A, B, T to block or release the ports, and provided with control edges formed on piston collars, and with a hydraulic pilot stage provided to control the spool valve of the main stage.

If the spool valve of a hydraulic control valve requires a control to release or block the valve housing ports, in addition to electromechanical pilot valves, hydraulically operating pilot stages are also known, in which a pilot valve, controlled by means of a connected drive, regulates a stream of hydraulic fluid acting upon the spool valve of the hydraulic main stage and therefore moving the spool valve between its control positions. When a hydraulic pilot stage arranged separately from the valve housing of the main stage is provided, a corresponding large size is obtained for such a hydraulic control valve and therefore a correspondingly large space requirement.

The underlying task of the invention is to provide a hydraulic control valve with a hydraulic pilot stage having limited space requirement. The solution to this task is obtained, including advantageous embodiments and modifications of the invention, from the content of the claims which follow this description.

In its main idea, the invention proposes that the spool valve of the main stage be designed hollow to form the hydraulic pilot stage, and a pilot valve movable by an external drive with a diameter smaller than the cavity be arranged in the cavity formed in the spool valve and be movable relative to the spool valve, the wall of the hollow spool valve being provided with a central inflow opening and with an outer outflow opening on both sides of it, and in which piston collars forming control edges, cooperating with the inflow opening and the outflow openings, are arranged on the pilot valve, and that two thrust plates are arranged in the valve housing enclosing the spool valve on its front ends and creating a pressure chamber for the spool valve on the ends sealed off on the housing side and the corresponding pressure chamber is connected to the annular space connected to the inflow opening via an inflow path that bridges a piston collar of the pilot valve assigned to the outflow openings.

The advantage that the pilot stage is moved into the main stage of the hydraulic control valve and the space requirements for the control valve overall are therefore reduced is initially connected with the invention. For this purpose, the invention exploits the hydraulic principle in a special way that the pilot stage with the pilot valve movable in both axial directions operates with four resistances, i.e., two resistances in each movement direction of the pilot valve. The hydraulic resistances consist, according to the invention, of the openings formed on the hollow spool valve in the form of at least one inflow opening and outflow openings, to which piston collars with control edges on them formed on the pilot valves are assigned, so that variable resistances are produced according to the position of the pilot valve within the spool valve. These resistances are set according to the use conditions for the hydraulic control valve, so that on the one hand, a displacement of the pilot valve as free of loss as possible by the connected drive is possible, but, on the other hand, sufficient control speeds of the control valve are attainable via a sufficiently large fluid flow.

According to one embodiment of the invention, it can then be prescribed that the pilot valve have a piston collar that penetrates the pressure chamber and the corresponding thrust plate in a bearing opening, and that the outflow openings be formed in the spool valve as openings opened toward the tank port in its neutral position, which are blocked in the neutral position of the pilot valve within the spool valve by the corresponding piston collar of the pilot valve. During displacement of the pilot valve, starting from its neutral position, hydraulic fluid is introduced into the annular space from the inflow opening released by the corresponding piston collar, in which case the outflow opening of the spool valve opened toward the tank is released by the corresponding piston collar on the side situated in the movement direction of the pilot valve.

If it is necessary in such an embodiment to connect the outer pressure chamber with the annular space separated from it by the piston collar, according to one practical example of the invention, it is prescribed that the inflow path be designed as a flat spot of the pilot valve forming a flow space between the pilot valve and the spool valve and the assigned outflow opening formed in the spool valve be arranged with an angle offset to the flat spot formed on the pilot valve, and that a torsion safeguard be provided for non-torsional guiding of the spool valve in the valve housing and the pilot valve relative to each other in all control positions. In order for the hydraulic fluid guided over the flat spots of the annular space into the pressure chamber not to flow out via the outflow openings covered by the piston collar, the offset arrangement of the flat spots and outflow openings is provided. This offset arrangement, however, also requires the provision of a torsion safeguard, so that the spool valve and pilot valve do not twist relative to each other during the control movements and the flat spots therefore can form an open flow path with the outflow openings.

The provision of a torsion safeguard can drop out if, in an alternative variant of the invention, it is prescribed that the inflow path be formed as a hole which passes through the piston collar of the pilot valve assigned to the outflow openings and connects the pressure chamber with the annular space, since the holes running in the piston collars do not connect with the outflow openings assigned to the piston collars.

With respect to an alterative embodiment of the inflow path, according to one practical example of the invention, it could be prescribed that the inflow path be designed as a hole running in the wall of the spool valve and connecting the pressure chamber with the annular space. The corresponding piston collar of the pilot valve can also be bridged in this way.

In an alternative variant with respect to arrangement of the outflow opening and the piston collar on the pilot valve, it is prescribed that the outflow openings in the spool valve be assigned in its neutral position to the consumer ports A and B, and that two control edges for the piston collar forming the outflow edges be arranged on the pilot valve, which are blocked in the neutral position of the pilot valve within the spool valve by the assigned piston collar of the pilot valve. This variant exploits the fact that, in the corresponding control position of the spool valve produced by movement of the pilot valve in the spool valve, one of the consumer ports A or B is always connected to the tank port, so that during displacement of the spool valve hydraulic fluid displaced from the pressure chamber can flow out to the tank via the assigned consumer port.

If it is also necessary in this practical example to bridge the piston collar situated between the annular space connected to the inflow opening and the pressure chamber, it can be prescribed according to the already described embodiment that the inflow path be designed as a hole passing through the piston collar assigned to the outflow openings and connecting the pressure chamber with the annular space.

Accordingly, in an alternative variant, it can again be prescribed that the inflow path be designed as a flat spot formed on the piston collars assigned to the outflow openings of the pilot valve, that the assigned outflow openings formed in the spool valve be arranged with an angular offset relative to the flat spots formed on the piston collars of the pilot valve, and that a torsion safeguard be provided for non-torsional guiding in the valve housing of the spool valve and the pilot valve relative to each other in all control positions.

It is prescribed according to a practical example of the invention that a plurality of inflow and outflow openings leading into the cavity of the spool valve be distributed in symmetric arrangement over the periphery of the spool valve.

In order to create the pressure chamber required for axial displacement of the spool valve of the main stage of the hydraulic control valve, according to a practical example of the invention, it is prescribed that the thrust plate have a peripheral recess to accommodate an axial protrusion of the spool valve on the front as a stop for the end position of the spool valve, whose depth is chosen so that in the end position of the spool valve an intermediate space remains between the thrust plate and the front of the spool valve as pressure chamber.

### BRIEF DESCRIPTION OF THE DRAWINGS

Practical examples of the invention, which is described below, are depicted in the drawings. In the drawing:

FIG. 1 shows a hydraulic control valve with integrated pilot stage in cross-section without depicting the corresponding drive for the pilot stage and other safety devices to be provided on a control valve, which are not affected by the invention,

FIG. 2 shows the object of FIG. 1 in a view rotated by 90°,

FIG. 3 shows another variant of a spool valve with a pilot valve situated in it in a merely schematic depiction for use in the control valve depicted in FIGS. 1 and 2.

### DETAILED DESCRIPTION

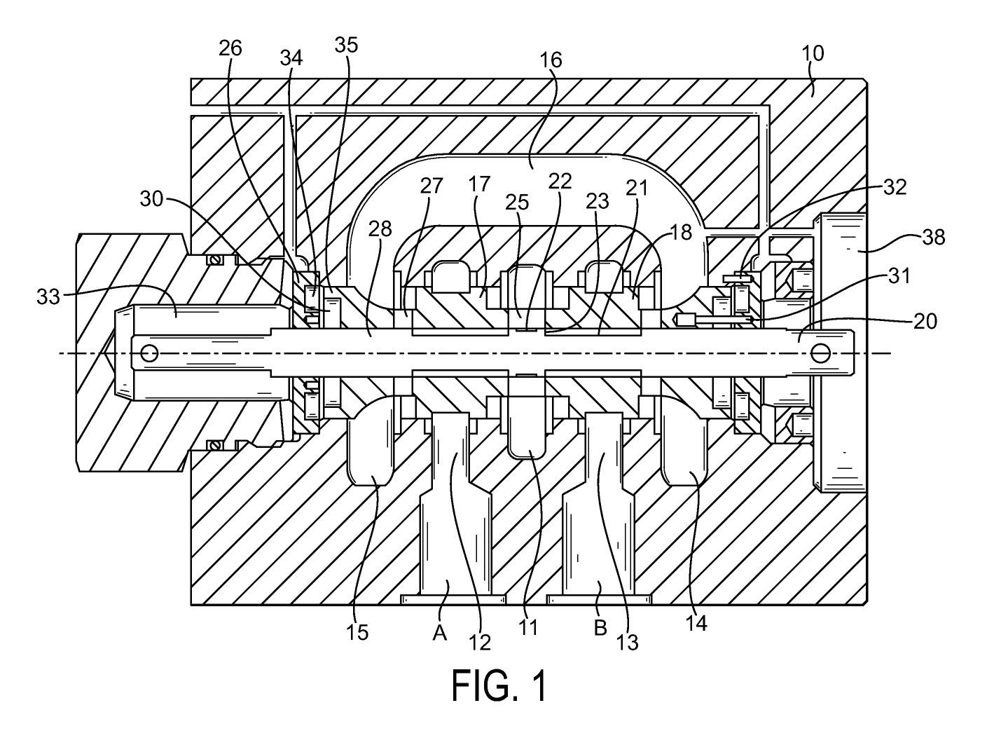

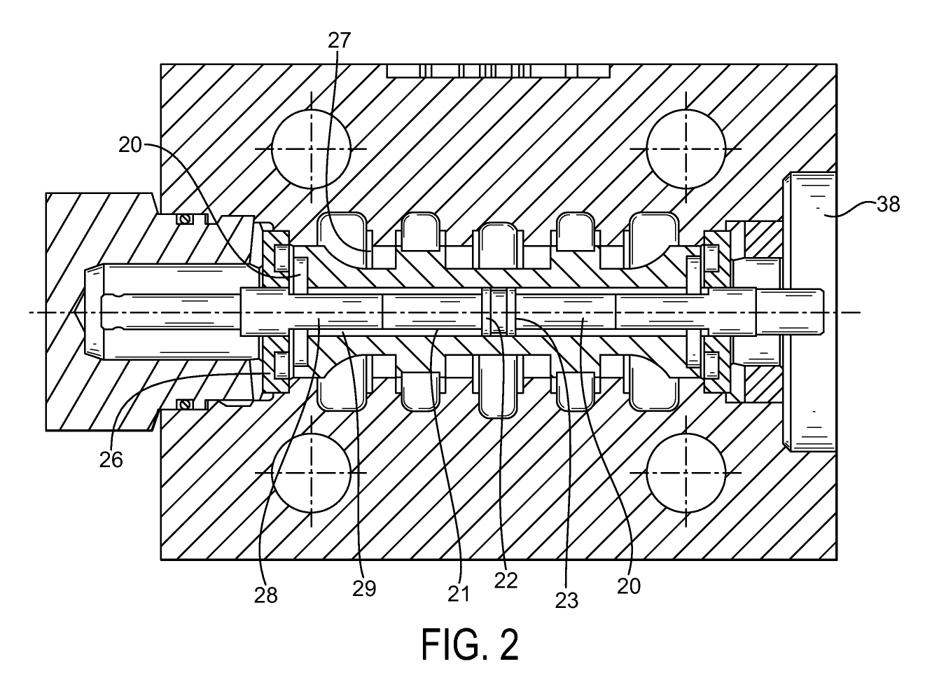

On the valve housing 10 of a hydraulic control valve shown in FIGS. 1 and 2, four standard ports P, A, B, T are formed, as such ports are common, but of which only the ports A and B are visible in the drawing. In known fashion, annular spaces are assigned to the ports in the valve housing 10, specifically an annular space 11 for the pump port P, an annular space 12 for the consumer port A and an annular space 13 for the consumer port B. Outer annular spaces 14 and 15 are also arranged in the depicted practical example, which are assigned to the tank port T, in which case the annular space 14 can be directly connected to the tank port T, whereas the annular space 15 is connected the annular space 14 via an internal bridge 16 and therefore to tank port T.

In the context of the control valve design known to this extent, a spool valve 17 is arranged movable in valve housing 10, on which two piston collars 18 with outer control edges are arranged, the piston collars 18 blocking annular spaces 12 and 13 in the neutral position of the control valve depicted in the drawing. During displacement of the spool valve 17, port of the annular space 11 either to annular space 12 or 13 occurs, in which case the other annular space 12 or 13 is connected accordingly to one of the annular spaces 14 or 15. In this way, the annular spaces 12, 13 of the consumer ports A, B are either acted upon with pump pressure or connected to the tank port.

To form a hydraulic pilot valve, the spool valve 17 is designed hollow and has an internal cavity, in which the pilot valve 20 is arranged movable relative to the spool valve. The pilot valve 20 has a smaller diameter than the cavity of the spool valve 17, so that an annular space 21 is produced for flow of a hydraulic fluid. A piston collar with outside control edges 22 is arranged on the pilot valve 20, which has a peripheral groove 24 for pressure equalization in the center. The piston collar 22 of the pilot valve 20 cooperates with two oppositely arranged openings 25 of the spool valve in the depicted practical example, which are connected to the annular space 11 connected to pump port P, so that the hydraulic fluid supplied by the pump is present on the openings 25 of spool valve 17. If a displacement of the pilot valve 20 to the left or right from the neutral position depicted in the drawing occurs, the connected control edge 23 of the piston collar 22 releases the corresponding opening 25, so that hydraulic fluid flows into the annular space 20, depending on the position of the pilot valve 20 in the cavity of spool valve 17.

The space penetrated by the spool valve 17 and traversed during its control movement is closed by the thrust plate 26 tightly arranged relative to the valve housing in valve housing 10, so that a pressure chamber 30 is formed between the thrust plate 26 and the end of the spool valve 17. The thrust plates 26 have a peripheral recess 34, which is made to accommodate an axially protruding protrusion 35 arranged on the front of the spool valve 17. The depth of the recess 34 relative to the axial extent of the protrusion 35 is dimensioned, so that in the end position of the spool valve 17, in which its axial protrusion 35 has entered the recess 34 of thrust plate 26, an intermediate space remains between the thrust plate 26 and the end of the spool valve 17 as pressure chamber 30.

The functional space 33 that accommodates the end of the pilot valve 20 is formed on the side of the thrust plate 26 in valve housing 10 facing away from the spool valve. Additional safety devices not necessary for understanding of the invention, like return springs, measurement systems or the like, can be arranged in the functional space.

In the depicted practical example on the right end of the pilot valve 20, an opening 38 is formed in the valve housing 10 for connection of an external, preferably electromechanical drive for the pilot valve 20.

As follows from examination of the two FIGS. 1 and 2, an outflow opening 27 open toward the corresponding tank port annular space 14 or 15 is formed on the spool valve 17, to which a piston collar 28 is assigned on the pilot valve 20, which, starting from the annular space 21, extends through the thrust plate 26 over the axial length of the pilot valve 20, so that the corresponding piston collar 28 simultaneously also forms a bearing and guide of the pilot valve 20 in the two outer thrust plates 26. Each piston collar 28 is then laid out, so that it blocks the assigned outflow opening 27 in the spool valve 17 within spool valve 17 in the neutral position of the pilot valve 20 depicted in FIGS. 1 and 2.

In order to create a flow path for inflow of hydraulic fluid from the annular space 21 into the pressure chamber 30, opposite flat spots 29 (FIG. 2) are formed on the corresponding piston collar 28 of the pilot valve 20, which form a flow space between the piston collar 28 and the pilot valve 20 and the spool valve 17 and therefore create an inflow path for the pressure chamber 30.

In order for hydraulic fluid not to directly escape through the outflow openings 27 during corresponding action of this inflow path, the flat spots 29 on the pilot valve 20 and the arrangement of the outflow openings 27 on the spool valves 17 are offset by 90° relative to each other, so that an open flow path is not formed.

In order to prevent torsion of the two parts relative to each other and therefore creation of an open flow path during the control movements of pilot valve 20 and spool valve 17, a torsion safeguard of the two components is provided. If the pilot valve 20 is secured against torsion in the interior of spool valve 17, because of its connection to an external drive (not shown), a separate torsion safeguard is formed in valve housing 10 for the spool valve 17. For this purpose, the spool valve 17 is fastened by means of a pin 31 to the corresponding thrust plate 26, in which case the thrust plate 26, in turn, is fastened via an additional pin 32 in valve housing 10, so that protection against torsion of the spool valve 17 of valve housing 10 is implemented via the two correspondingly provided pins 31, 32.

If the pilot valve 20 is displaced leftward by means of the drive (not shown) from the neutral position depicted in the drawing, the right control edge 23 (in the drawing depiction) of the piston collar 22 formed on pilot valve 20 releases the inflow opening 25 into the spool valve 17, so that hydraulic fluid supplied by the pump flows rightward into annular space 21. From here the hydraulic fluid flows into pressure chamber 30 via the flat spots 29 formed in the right piston collar 28 of the pilot valve 20, so that a pressure builds up in pressure chamber 30 that also leads to displacement of the spool valve 17 leftward. On the opposite left side of pilot valve 20 and spool valve 17, the fluid present there in pressure chamber 30 must be displaced according to the movement of the spool valve leftward. This fluid can flow back into annular space 21 via the flat spots 29 arranged in the left piston collar 28 of the pilot valve 20. Since the corresponding control edge of the piston collar 28 has released the outflow opening 27, because of the leftward offset position of the pilot valve 20 relative to spool valve 17, the hydraulic fluid displaced from the left pressure chamber 30 can now flow out into the annular channel 15 via the flat spots 29, annular space 21 and outflow opening 27 and into the tank via the internal bridge 16.

As not further shown, the flow paths produced by the flat spots 29 can also be replaced by holes arranged in the piston collars 28 of the pilot valve 20, which directly connect the annular space 21 to pressure chamber 30, in which case no connection is present between the holes and the outflow openings 27. Inflow and outflow of hydraulic fluid occur as described; however, in this case, a special protection against torsion, especially of the spool valve 17 in valve housing 10, is not necessary.

According to an alternative also not shown, the flow paths produced by the flat spots 29 can also be shifted into the wall of the spool valve 17 by arranging there at least one hole that connects the pressure chamber 30 to annular space 21.

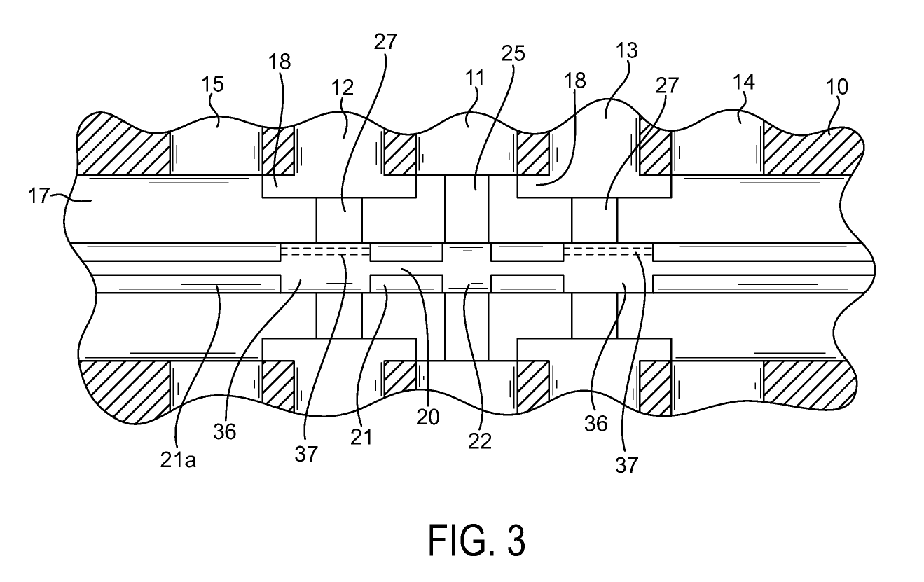

The practical example depicted in FIG. 3 differs from the practical example described above for FIGS. 1 and 2 in that the outflow openings 27 according to the invention in the spool valve 17 are now assigned to the annular spaces 12 and 13 corresponding to the consumer ports A and B of valve housing 10. Since control edges on the pilot valve 20 are also assigned to these outflow openings 27, the pilot valve 20 has a piston collar 36 assigned to the two outflow openings 27 of the spool valve 17, which block the outflow opening 27 within spool valve 17 in the neutral position of the pilot valve 20 depicted in FIG. 3. Owing to the arrangement of these two piston collars 36, an annular space 21 on the inflow side and an annular space 21a on the outflow side are produced, which are connected, in turn, to the pressure chamber 30 lying on the outside. In order to permit an inflow path from the annular space 21 on the inflow side into pressure chamber 30, holes 37, via which the fluid can flow, which pass through the piston collar 36, are arranged in the practical example depicted in FIG. 3.

The control movements occur in this practical example in the same manner as described for FIGS. 1 and 2. During corresponding adjustment of the pilot valve 20 within spool valve 17, fluid is admitted into annular space 21 on the inflow side, which flows into the pressure chamber 30 on the pressure side via the holes 37. On the other side, the hydraulic fluid displaced from the pressure chamber 30 there can flow into the annular space 21 via the holes 37 of the corresponding piston collar 36, which is now open to corresponding outflow opening 27 in spool valve 17, however, owing to the offset position of the pilot valve 20 relative to spool valve 17, so that a connection is present between the annular space 21 and the assigned consumer port A or B. Since the corresponding consumer port is connected to the tank in the corresponding position of the spool valve 17, a corresponding outflow of the fluid displaced from the pressure chamber 30 to the tank also occurs here.

The features of the object of this document, disclosed in the preceding description, and the claims, summary and drawing, can be essential individually and in any combination with each other for implementation of the invention in its different variants.

1. Hydraulic control valve with a main stage, having spool valves movable in a valve housing having at least four ports P, A, B, T to block or release the ports and provided with control edges formed on piston collars, and with a hydraulic pilot stage provided to control the spool valve of the main stage, characterized by the fact that the spool valve of the main stage is designed hollow to form the hydraulic pilot stage, and a pilot valve movable by an external drive in the cavity formed in spool valve is arranged with a smaller diameter relative to the cavity and forming an annular space on this account and is movable relative to the spool valve, the wall of the hollow spool valve being provided with a central inflow opening and with an outer outflow opening on both sides of it, and piston collars forming control edges cooperating with the inflow window and the outflow windows are arranged on the pilot valve, and that two thrust plates that enclose the spool valve on its front ends and create a front pressure chamber for the spool valves closed off on the housing side are arranged in the valve housing, and the corresponding pressure chamber is connected to the annular space connected to the inflow opening via an inflow path that bridges the piston collars of the pilot valve assigned to the outflow openings.

2. Hydraulic control valve according to claim 1, characterized by the fact that the pilot valve has a piston collar that penetrates the pressure chamber and the corresponding thrust plate in a bearing opening, and that the outflow openings in the spool valve are formed as openings open to the tank port in its neutral position, which are blocked in the neutral position of the pilot valve within the spool valve by the corresponding piston collar of the pilot valve.

3. Hydraulic control valve according to claim 2, characterized by the fact that the inflow path is formed as a flat spot of the pilot valve that forms a flow space between the pilot valve and the spool valve and the outflow opening formed in the spool valve is arranged with an angular offset to the flat spot formed on the pilot valve, and that a torsion safeguard is provided for non-torsional guiding of the spool valve in the valve housing and the pilot valve relative to each other in all control positions.

4. Hydraulic control valve according to claim 2, characterized by the fact that the inflow path is formed as a hole that penetrates the piston collars assigned to the outflow openings and connects the pressure chamber to annular space.

5. Hydraulic control valve according to claim 2, characterized by the fact that the inflow path is formed as a hole running in the wall of the spool valve and connecting the pressure chamber to annular space.

6. Hydraulic control valve according to claim 1, characterized by the fact that the outflow openings in the spool valve are assigned in its neutral position to the consumer ports A and B and piston collar forming two control edges for the outflow openings is arranged on the pilot valve, which are blocked in the neutral position of the pilot valve within the spool valve by the corresponding piston collar of the pilot valve.

7. Hydraulic control valve according to claim 6, characterized by the fact that the inflow path is formed as a hole that penetrates the piston collar assigned to the outflow openings and connecting the pressure chamber to annular space.

8. Hydraulic control valve according to claim 6, characterized by the fact that the inflow path is formed as a flat spot formed on the piston collar of the pilot valve assigned to the outflow openings and the corresponding outflow openings formed in the spool valve are arranged with an angular offset to the flat spots formed on the piston collars of the pilot valve, and that a torsion safeguard is provided in the valve housing for non-torsional guiding of the spool valve and the pilot valve relative to each other in all control positions.

9. Hydraulic control valve according to one of the claims 1 to 8, characterized by the fact that a plurality of inflow openings and outflow openings leading into the cavity of the spool valve are arranged over the periphery of the spool valve distributed in symmetric arrangement.

10. Hydraulic control valve according to one of the claims 1 to 9, characterized by the fact that the thrust plates have a peripheral recess to accommodate an end axial protrusion of the spool valve as a stop for the end position of the spool valve, whose depth is dimensioned so that an intermediate space remains between the thrust plate and the end of the spool valve as a pressure chamber in the end position of the spool valve.
